(19) United States
(12) Patent Application Publication
(10) Pub. No.: US 2018/0348753 A1
(43) Pub. Date: Dec. 6, 2018

(54) REAL TIME ROAD FLOOD LEVEL DETECTION

(71) Applicant: Continental Automotive Systems, Inc., Auburn Hills, MI (US)

(72) Inventors: Abel Ortiz Gonzalez, Zapopan (MX); Oliver de Jesus Lopez Sanchez, Tlajomulco de Zuniga (MX); Aldo Orozco Gomez, Guadalajara (MX)

(73) Assignee: Continental Automotive Systems, Inc., Auburn Hills, MI (US)

(21) Appl. No.: 15/608,335

(22) Filed: May 30, 2017

(51) Int. Cl. G05D 1/00; G01B 21/18; B60W 50/14

(52) U.S. Cl. CPC G05D 1/0061; G01S 17/88; B60W 50/14; G01B 21/18

(57) ABSTRACT

A flood level detection system for a vehicle, which includes at least one sensor, and an interface. The sensor detects the depth of an area of accumulated water in proximity to the vehicle, and then communicates the depth of the area of accumulated water to the interface. The interface then communicates to the driver of the vehicle whether the depth of the area of accumulated water is greater than or less than the maximum allowable depth that the vehicle may tolerate. The vehicle may include a driver Human-Machine Interface (HMI), and the interface may be part of the driver HMI. However, in other embodiments, the interface may be part of the vehicle instrument cluster, or other part of the vehicle. The sensor in one embodiment is a laser sensor, but in other embodiments, the sensor may be a LIDAR sensor, a LADAR sensor, radar, or a sonar sensor.

### FIELD OF THE INVENTION

The invention relates generally to a system for detecting the depth of an upcoming puddle, or area of accumulated water, such that a vehicle may avoid traversing the area of water which has a depth that is greater than the maximum allowable depth that the vehicle may travel to avoid engine stall or damage to the components of the vehicle.

### BACKGROUND OF THE INVENTION

Automobiles travel though many different types of environments, and are exposed to various weather conditions as well. Occasionally, automobiles travel during or after periods of heavy rain, where flooding may occur, and large amounts of water may accumulate on various roads. Some of the water may pool and form puddles or large areas of accumulated water, which may be very deep. Automobiles typically have a limit as to how deep a puddle of water may be that the vehicle may pass through without incurring damage to the vehicle. This limit may vary depending upon the type of vehicle. Different vehicles have varying ground clearances, engine placement relative to the ground, and various locations of the intake and exhaust. These various vehicle characteristics may affect how deep of an area of accumulated water the vehicle may travel through.

When traveling along roads where there are large puddles of water, it may be very difficult for the driver of the vehicle to determine whether the depth of the puddle is beyond the allowed depth through which the vehicle is allowed to travel safely, and without being damaged. If the driver of the vehicle were to attempt to travel through a puddle which is deeper than the allowable limit for that vehicle, the vehicle may get stuck in the puddle due to engine stall from water exposure, or even if the vehicle is able to traverse the water puddle, the vehicle may incur damage due to excessive water exposure.

Accordingly, there exists a need for a device which is able to detect the depth of an upcoming pool of accumulated water, or water puddle, such that a vehicle may avoid traveling through a pool of water having a depth which is beyond an acceptable limit.

### SUMMARY OF THE INVENTION

The present invention is a system for detecting the depth of a puddle or an area of accumulated water such that a vehicle may avoid traversing an area of water which has a depth that is greater than the maximum allowable depth that the vehicle may travel. This reduces or eliminates engine stall and damage to the components of the vehicle.

In an embodiment, the present invention is a flood level detection system for a vehicle, which includes at least one sensor, and an interface. The sensor detects the depth of an area of accumulated water in proximity to the vehicle, and then communicates the depth of the area of accumulated water to the interface. The interface then communicates to the driver of the vehicle whether the depth of the area of accumulated water is greater than or lesser than the maximum allowable depth that the vehicle may tolerate.

The vehicle may include a driver Human-Machine Interface (HMI), and the interface may be part of the driver HMI. However, in other embodiments, the interface may be part of the vehicle instrument cluster, or other part of the vehicle.

The sensor in one embodiment is a laser sensor, but in other embodiments, the sensor may be a LIDAR sensor, a LADAR sensor, radar, or a sonar sensor.

In another embodiment, the vehicle is decelerated independently of driver input when the depth of the area of accumulated water is greater than the maximum allowable depth the vehicle may tolerate. This deceleration function may be part of an autonomous driving vehicle function.

In one embodiment, the sensor is attached to the grille. However, it is within the scope of the invention that the sensor may be attached to other areas of the vehicle as well, such as, but not limited to, the bumper, hood, windshield, and roof.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a vehicle traveling along a road, where the vehicle has a flood level detection system, according to embodiments of the present invention; and

FIG. 2 is a diagram of a sensor communicating with an interface to communicate to the driver of a vehicle the depth of an area of accumulated water, where the sensor and the interface are part of a flood level detection system, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

Referring to the Figures generally, an example of a vehicle incorporating a flood level detection system according to the present invention is shown generally at 10. The system includes a sensor 12, which is mounted to the vehicle 10. In this embodiment, the sensor 12 is mounted to the grille 14 of the vehicle 10, but it is within the scope of the invention that the sensor 12 may be mounted to other locations on the vehicle 10, such as, but not limited to, the bumper, hood, windshield, and roof.

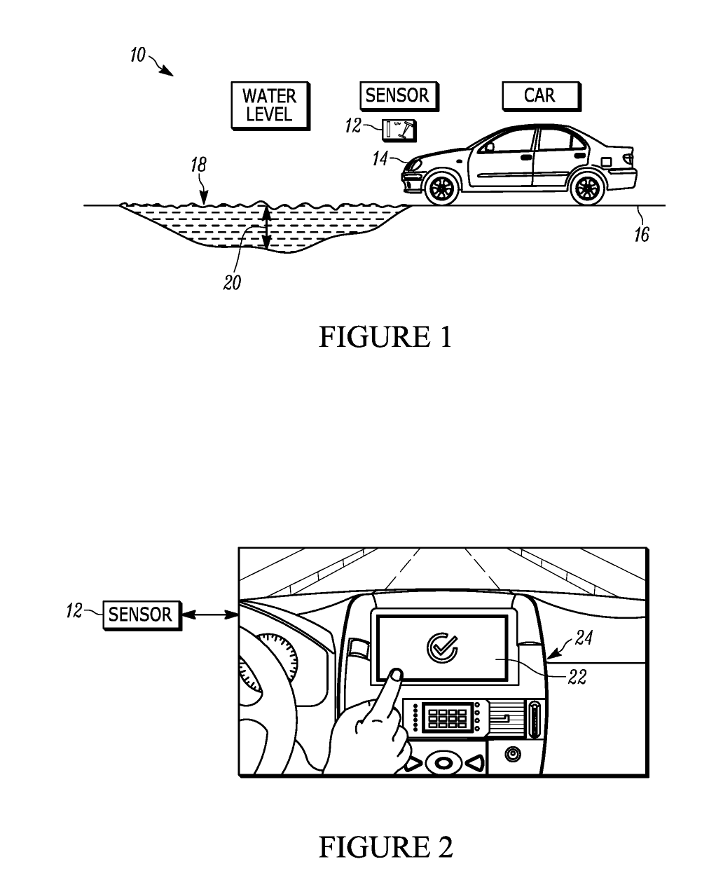

The vehicle 10 is able to travel along a road 16, the road 16 shown in FIG. 1 in this example has a puddle of water, or an area of accumulated water, shown generally at 18, which is in the path of travel of the vehicle 10. The area 18 of accumulated water may be the result of flooding caused by heavy rain. When looking at the area 18 of accumulated water, the driver of the vehicle 10 may not be able to determine the depth 20 of the area 18 of accumulated water while driving. The vehicle 10 has a maximum allowable depth the area 18 of accumulated water may be without the occurrence of engine stall, or causing damage to the vehicle 10. If the depth 20 of the area 18 is greater than the maximum allowable depth of accumulated water tolerable by the vehicle 10, the vehicle 10 may suffer engine stall, or various components of the vehicle 10 may become damaged due to water exposure.

The system also includes an interface 22 which is used to provide communication to the driver that the area 18 is safe to pass through, or that the depth 20 of the area 18 of accumulated water is beyond the maximum allowable depth of water tolerable for the vehicle 10. In this embodiment, the interface 22 is part of the Human-Machine Interface (HMI), shown generally at 24 in FIG. 2. However, it is within the scope of the invention that the interface 22 may be located in other parts of the vehicle 10, such as the instrument cluster. The interface 22 may also provide communication with the driver of the vehicle 10 in a number of ways. The interface 22 may function as a tell-tale, either indicating the area 18 is safe to pass through, or the depth 20 of the area of water is beyond the maximum allowable depth of accumulated water tolerable by the vehicle 10.

During operation, as the vehicle 10 is travelling down the road 16, and the area 18 of accumulated water is approached, the sensor 12 detects the depth 20 of the area 18 of accumulated water. The sensor 12 is able to detect the depth 20 of the area 18 of accumulated water beginning at a distance of at least fifty meters away. In this embodiment, the vehicle 10 is travelling at speeds of eighty kilometers per hour or less, depending upon the weather conditions. During conditions where flooding may occur, and water accumulates on different parts of the road 16, it is presumed that the vehicle 10 is travelling at speeds that are safe relative to weather and driving conditions, which are typically less than highway speeds. Furthermore, the vehicle 10 must be travelling slow enough such that there is enough time for the vehicle 10 to slow down, or stop, if the depth 20 the area 18 of accumulated water is greater than the maximum allowable depth that the vehicle 10 may tolerate. In this embodiment, if the vehicle 10 is travelling at eighty kilometers per hour or less, the vehicle 10 has enough time and distance to slow down if needed, and avoid the area 18 of accumulated water. If the sensor 12 detects that the depth 20 of the area 18 of accumulated water is greater than the maximum allowable depth that the vehicle 10 may tolerate, the interface 22 alerts the driver of the vehicle 10 to avoid the area 18 of accumulated water. If the sensor detects that the depth 20 of the area 18 of accumulated water is less than the maximum allowable depth that the vehicle may tolerate, the interface alerts the driver of the vehicle 10 that the vehicle 10 may pass through the area 18 of accumulated water.

In an alternate embodiment, the vehicle 10 may be equipped with an additional function, where upon detection of the depth 20 of the area 18 of accumulated water, where the vehicle 10 is decelerated automatically (independently of driver input) when the depth 20 of the area 18 of accumulated water is greater than the maximum allowable depth that the vehicle 10 may tolerate. This function may also be included with a function that still allows for driver control of the vehicle 10 in an emergency situation.

In yet another embodiment, the vehicle 10 may be decelerated automatically (independently of driver input) as part of an autonomous driving vehicle function when the depth 20 of the area 18 of accumulated water is greater than the maximum allowable depth that the vehicle 10 may tolerate. When operating in an autonomous driving mode, and the depth 20 of the area 18 of accumulated water is greater than the maximum allowable depth that the vehicle 10 may tolerate, the vehicle 10 may attempt to merge into an adjacent lane of travel, or decelerate completely to a stop.

As mentioned above, the sensor 12 is able to detect the depth 20 of the area 18 of accumulated water beginning at a distance of at least fifty meters away, and the vehicle 10 is travelling at eighty kilometers per hour or less. However, different types of sensors may be used where the sensor 12 is able to detect the depth 20 of the area 18 of accumulated water from a greater distance, such that the vehicle 10 is able to travel at speeds greater than eighty kilometers per hour, the depth 20 of the area 18 of accumulated water is detected by the sensor 12, and there is enough distance between the vehicle 10 and the area 18 of accumulated water that the area 18 of accumulated water may be avoided if needed. In the embodiments described above, the sensor 12 is a laser sensor, which detects the depth 20 of the area 18 of accumulated water through diffraction. However, it is within the scope of the invention that other types of sensing devices may be used, such as, but not limited to, LIDAR (Light Imaging, Detection, and Ranging), LADAR (Laser Imaging, Detection, and Ranging), radar, or sonar.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A flood level detection system for a vehicle, comprising:
at least one sensor; and
an interface;
wherein the sensor detects a depth of an area of accumulated water in proximity to the vehicle, and communicates the depth of the area of water to the interface, and the interface communicates to the driver whether the depth of the area of accumulated water is greater than or lesser than the maximum allowable depth the vehicle may tolerate.

2. The flood level detection system for a vehicle of claim 1, wherein the vehicle is decelerated independently of driver input when the depth of the area of accumulated water is greater than the maximum allowable depth the vehicle may tolerate.

3. The flood level detection system for a vehicle of claim 1, wherein the vehicle is decelerated independently of driver input as part of an autonomous driving function.

4. The flood level detection system for a vehicle of claim 1, further comprising a grille, the grille being part of the vehicle, wherein the at least one sensor is mounted to the grille.

5. The flood level detection system for a vehicle of claim 1, further comprising a driver HMI, wherein the interface is part of the driver HMI.

6. The flood level detection system for a vehicle of claim 1, wherein the at least one sensor is one selected from the group consisting of a laser, a LIDAR sensor, a LADAR sensor, radar, and sonar.

7. A method for determining if an area of water is safe to travel through, comprising the steps of:
providing a sensor mounted to a vehicle;
providing an interface;
providing a maximum allowable depth of water through which the vehicle may travel;
detecting a depth of an area of accumulated water using the sensor;
using the interface to inform the driver of the vehicle that the depth of the area of accumulated water is above or below the maximum allowable depth of water through which the vehicle may travel.

8. The method of claim 7, further comprising the steps of selecting the sensor to be one selected from the group consisting of a laser, a LIDAR sensor, a LADAR sensor, radar, and sonar.

9. The method of claim 7, further comprising the steps of:
providing a grille, the grille being part of the vehicle;
mounting the sensor to the grille of the vehicle such that the sensor detects the depth of the area of accumulated water.

10. The method of claim 7, further comprising the steps of decelerating the vehicle independently of driver input when the depth of the area of accumulated water is greater than the maximum allowable depth the vehicle may tolerate.

11. The method of claim 7, further comprising the steps of providing a driver HMI, and the interface is part of the driver HMI.
